(19) United States
(12) Patent Application Publication
(10) Pub. No.: US 2021/0041711 A1
(43) Pub. Date: Feb. 11, 2021

(54) Compact Polarization-Based Collimators with High Contrast

(71) Applicant: Gary Sharp Innovations, LLC, Boulder, CO (US)

(72) Inventors: GARY D. SHARP, BOULDER, CO (US); ANTHONY D. MCGETTIGAN, Santa Rosa, CA (US)

(21) Appl. No.: 16/923,705

(22) Filed: Jul. 8, 2020

Related U.S. Application Data
(60) Provisional application No. 62/871,680, filed on Jul. 8, 2019.

(51) Int. Cl. G02B 27/28; G02B 17/00; G02B 27/00

(52) U.S. Cl. CPC G02B 27/281; G02B 27/286; G02B 27/0018; G02B 17/004

(57) ABSTRACT

High-performance polarization-based triple-pass lenses require precise management of polarization over a range of incidence angles and wavelengths. These lenses have the potential to provide high optical power in a compact arrangement, as needed for (e.g.) wide field-of-view near-eye immersive display applications. Accordingly, disclosed herein is a wide-angle polarization-based triple-pass lens that includes an input polarizer producing a first transmitted linear polarization; a first retarder-stack for converting from linear-polarization to circular-polarization; a curved partial-reflector; a second retarder-stack for converting from circular-polarization to linear-polarization; a reflective linear-polarizer; and a geometric-compensator (GC) between the input polarizer and the first retarder-stack, the second quarter-wave retarder and the reflective linear-polarizer, or both. The GC reduces the first-pass transmission of the lens for rays incident off-normal.

### CROSS-REFERENCE

This application claims priority to U.S. Provisional Application No. 62/871,680 filed Jul. 8, 2019, the contents of which are incorporated herein by reference in its entirety.

### BACKGROUND

Polarization-based triple-pass lenses are known to enable wide-angle compact collimators. But inadequate polarization management can generate stray-light that compromises the quality of a visual experience when using such a lens in, for example, a virtual-reality head-set. This can take the form of veiling glare, diffuse background scatter, and ghost images. For example, one set of ghost images may be attributed to lack of control in converting (back/forth) between linear and circular polarization basis vectors. Another set can be associated with Fresnel reflections that are not extinguished and exit efficiently to the viewer.

### SUMMARY

Optimized optical configurations for managing polarization in polarization-based triple-pass lenses are described. The lens can be analyzed by breaking optimization into two steps, and thus two relevant optical systems. The first optimization can be associated with minimizing transmission of first-pass light, and the second optimization can be associated with precisely managing polarization for second/third-pass light. The latter may be coupled with minimizing power associated with fourth-pass light, or maximizing polarization conversion in second/third passes. Ghosts associated with (Fresnel) reflections are analyzed as a separate matter, and an optical arrangement is given to mitigate these contributions.

Disclosed herein is a wide-angle polarization-based triple-pass lens that includes an input polarizer producing a first transmitted linear polarization; a first retarder-stack for converting from linear-polarization to circular-polarization; a curved partial-reflector; a second retarder-stack for converting from circular-polarization to linear-polarization; a reflective linear-polarizer; and a geometric-compensator (GC) between the input polarizer and the first retarder-stack, the second quarter-wave retarder and the reflective linear-polarizer, or both. The GC reduces the first-pass transmission of the lens for rays incident off-normal.

The absorptive linear-polarizer may be o-type in transmission, the reflective-polarizer o-type in reflection, and the absorption-axis crossed with the reflection-axis. The geometric-compensator may be comprised of a positive A-plate with 70-130 nm of phase-difference, and a positive C-plate with 70-130 nm of phase-difference. The second retarder stack may have a reverse-order-reflection-about-zero relationship with the first retarder stack. The lens may further include a positive C-plate between the first retarder-stack and the partial-reflector, the partial-reflector and the second retarder-stack, or both, wherein the positive C-plate retardation is selected to minimize the transmission of first-pass light for rays incident off-normal. The lens may further include a diattenuation-compensator between the first retarder-stack and the partial-reflector, the partial-reflector and the second retarder-stack, or both, wherein the absorption of the diattenuation-compensator is selected to minimize the transmission of first-pass light for rays incident off-normal.

Also disclosed is a wide-angle magnified imaging system that includes a display device; an input polarizer producing a first transmitted linear polarization; a first retarder-stack for converting from linear-polarization to circular-polarization; a curved partial-reflector; a second retarder-stack for converting from circular-polarization to linear-polarization; a reflective linear-polarizer; and a geometric-compensator (GC) between the input polarizer and the first retarder-stack, the second quarter-wave retarder and the reflective linear-polarizer, or both. The GC reduces the first-pass transmission of the lens for rays incident off-normal.

The absorptive linear-polarizer may be o-type in transmission, the reflective-polarizer is o-type in reflection, and the absorption-axis is crossed with the reflection-axis. The geometric-compensator may be comprised of a positive A-plate with 70-130 nm of phase-difference, and a positive C-plate with 70-130 nm of phase-difference. The second retarder stack may have a reverse-order-reflection-about-zero relationship with the first retarder stack. The imaging system may further include a positive C-plate between the first retarder-stack and the partial-reflector, the partial-reflector and the second retarder-stack, or both, wherein the positive C-plate retardation is selected to minimize the transmission of first-pass light for rays incident off-normal. The imaging system may further include a diattenuation-compensator between the first retarder-stack and the partial-reflector, the partial-reflector and the second retarder-stack, or both, wherein the absorption of the diattenuation-compensator is selected to minimize the transmission of first-pass light for rays incident off-normal.

Also disclosed is a wide-angle magnified imaging system with reduced ghosting that includes a display device; an input absorptive polarizer affixed to the display device producing a first transmitted linear polarization; a curved reflective linear-polarizer physically separated from the input polarizer; a first retarder-stack for converting from linear-polarization to circular-polarization; a partial-reflector; a second retarder-stack for converting from circular-polarization to linear-polarization; and an analyzing absorptive linear polarizer with absorption-axis crossed with the input polarizer absorption-axis.

The curved reflective-polarizer, the first retarder-stack, the partial reflector, the second retarder-stack, and the analyzing polarizer may all be optically coupled to minimize reflections. The curved reflective polarizer may form an input convex surface and the concave surface may be filled with an isotropic index-matching dielectric, forming a planar surface for coupling to the input retarder-stack. The partial-reflector may be planar. The curved reflective polarizer may be physically separated from the first retarder-stack, and the first-retarder stack, the partial reflector, the second retarder-stack, and the analyzing polarizer may all be optically coupled. The output surface of the curved reflective polarizer and the input surface of the first quarter-wave retarder may have an anti-reflection coating.

The wide-angle magnified imaging system may further include a geometric-compensator (GC) between the reflective polarizer and the first retarder stack, the second retarder-stack and the analyzing absorptive polarizer, or both, wherein the GC reduces the first-pass transmission of the lens for rays incident off-normal. The geometric-compensator may be comprised of a positive A-plate with 70-130 nm of phase-difference, and a positive C-plate with 70-130 nm of phase-difference. The second retarder stack may have a reverse-order-reflection-about-zero relationship with the first retarder stack. The wide-angle magnified imaging system may further include a positive C-plate between the first retarder-stack and the partial-reflector, the partial-reflector and the second retarder-stack, or both, wherein the positive C-plate retardation is selected to minimize the transmission of first-pass light for rays incident off-normal. The wide-angle magnified imaging system may further include a diattenuation-compensator between the first retarder-stack and the partial-reflector, the partial-reflector and the second retarder-stack, or both, wherein the absorption of the diattenuation-compensator is selected to minimize the transmission of first-pass light for rays incident off-normal.

### DESCRIPTION OF FIGURES

FIG. 1. Exploded view of optical system associated with first-pass light.

FIG. 2. Optical arrangement containing a geometric compensator.

FIG. 3. Contrast comparison for a pair of crossed-polarizers versus a pair of crossed-polarizers with geometric compensation of the invention.

FIG. 4. Example of polarization-based triple-pass lens optimized for first-pass light.

FIG. 5. Contrast versus incidence angle for the arrangement of FIG. 4.

FIG. 6. Exploded and unfolded view of optical system associated with second/third-pass light.

FIG. 7. Example of exploded and unfolded view of optical system optimized for second/third-pass light.

FIG. 8. Contrast versus incidence angle for the arrangement of FIG. 7.

FIG. 9. Example of triple-pass lens of the invention optimized for first-pass and second/third-pass light.

FIG. 10. Prior art triple-pass lens showing trace of two display reflection ghosts

FIG. 11. Example triple-pass lens of the invention showing reduced display reflection ghost.

### DETAILED DESCRIPTION

First-Pass Optimization

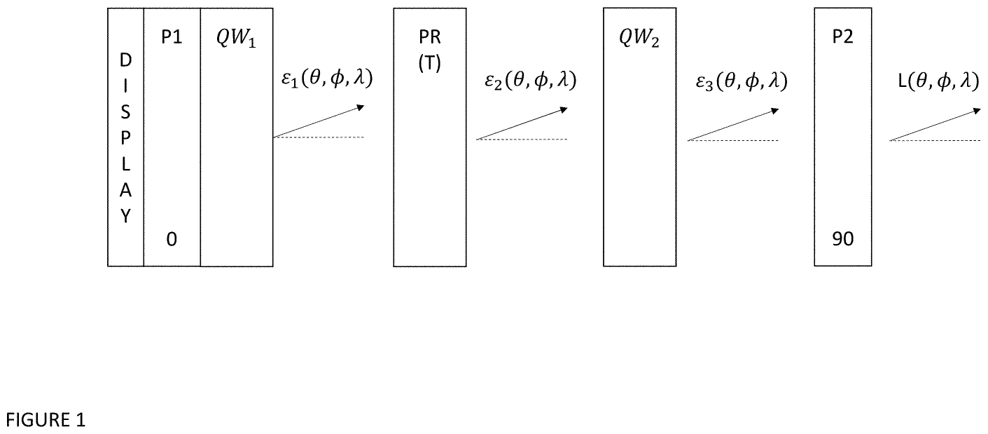

FIG. 1 shows an exploded view of a prior-art optical system relevant to first-pass light of a polarization-based wide-angle collimator. Image light generated by (e.g.) a liquid-crystal display (LCD) may have a shared linear polarizer (P1) which may serve as the display analyzer and the input for a circular polarizer. The circular polarization may be generated by one or more layers of anisotropic material (QW₁), collectively providing a quarter-wave of retardation. The actual output may be represented by an incidence-angle and wavelength-dependent ellipticity, ε₁(θ, ϕ, λ). This is followed by a partial-reflector (PR) which forms the first layer of an optical cavity. This component may have a material impact on the state-of-polarization (SOP), transforming it to an ellipticity ε₂(θ, ϕ, λ). A second quarter-wave retarder (QW₂) may be used to (ideally) restore the original linear SOP. The final ellipticity ε₃(θ, ϕ, λ), is minimally the result of the impact of the three elements described. Not represented, but of significance, is the orientation of this elliptical SOP (versus angle/wavelength). A reflective polarizer (P2) serves as the analyzer for the SOP of first-pass light, which also forms the second layer of an optical cavity.

The analysis considers only the first-pass light and not reflections that may occur between the layers shown. In practice, these surfaces may be substantially eliminated via optical coupling (e.g. an adhesive with a matched refractive index). Note also that any impact from a difference in ray angle through each element associated with imaging optics is not considered in this simplified analysis. An optimized design produces zero transmitted lumens (L(θ, ϕ, λ)), over all relevant angles-of-incidence (AOI), azimuth-angles, and wavelengths, respectively. The AOI is with respect to the display-normal and the azimuth defines the local plane-of-incidence (POI). The functional elements for achieving a first-pass null in transmission are the input polarizer (P1), and the reflective polarizer (P2), where the absorption axis of the former is preferably crossed with the reflection axis of the latter. This means that no actual polarization transformation is required between polarizers to null transmission. At normal-incidence, that optimization calls for the elements between the polarizers to collectively “vanish”; to introduce zero net rotation and ellipticity. But if this were the case, the performance is not necessarily optimal for off-normal light. This may be purely due to geometry, because crossed polarizers typically only perform optimally off-normal when the POI contains one of the polarizer axes.

Geometric Rotation

Optimization of the first-pass entails minimizing transmission to the viewer over all wavelengths and incidence angles. The input polarizer is typically an iodine or dye-stuff polarizer, where the absorption axis is in the PVA (poly-vinyl-alcohol) stretching direction. This corresponds to the extraordinary axis, so these polarizers are known as o-type because they transmit light orthogonal to the extraordinary axis (i.e. they transmit ordinary light). The analyzer is a reflective polarizer, which is typically either a wire-grid polarizer (WGP) or a stretched multi-layer polymer. Examples of the former include WGP products from Asahi Kasei, or Moxtek, and an example of the latter is the stretched co-extruded product by 3M (e.g. DBEF). One way of mitigating issues with geometric rotation off-normal is to use a reflective polarizer that is e-type in transmission. In this case, crossing the axes is synonymous with co-alignment of the extraordinary axes. Since geometrical rotations are common to both polarizers, the contrast can remain high at all incidence angles. The invention includes the combination of an o-type input polarizer and an e-type reflective polarizer (in transmission) or vice-versa, which can be helpful in simplifying the compensation requirements.

In the case where the polarizers are either both o-type or both e-type, there may be an issue with leakage due purely to geometry. That is, in the ±45° azimuth, geometric counter-rotation of polarizer axes causes leakage that can limit performance. This is known (e.g.) as the “Dreaded-X” problem that photographers/videographers face when using variable neutral density filters in high density settings. In the worst-case (±45°) azimuth, the contrast of ideal crossed linear polarizers is 1,000:1 at 24° AOI, 500:1 at 28° AOI, 200:1 at 36° AOI, and 100:1 at 44° AOI. The invention recognizes this performance limiter and may include an auxiliary geometric compensator (GC), such as an A-Plate/C-Plate combination that engages off-normal to correct the SOP as needed. Alternatively, the invention may integrate geometric compensation into the functional requirements for existing polarization management components. These include the polarization transformations necessary for optimizing the second optical configuration (i.e. that for second/third-pass light). Any set of components that produces off-normal contrast that is higher than that which would be achieve with crossed polarizers alone is considered to have an integrated GC function.

A stand-alone geometric compensator (GC) of the invention can serve as the starting point for an optimized design when using crossed o-type polarizers. By placing it adjacent to either polarizer, the appropriate polarization correction can be applied to ensure high-contrast at all incidence angles. Specifically, small rotations are applied by the compensator as needed such that the SOP projects only along the reflection-axis of the reflective polarizer regardless of incidence angle/azimuth. And in this case, the other functional components (e.g. QWs) do not have the additional burden of correcting geometric rotation. Alternatively, the combination may work in a complementary fashion to provide higher performance than might otherwise be feasible.

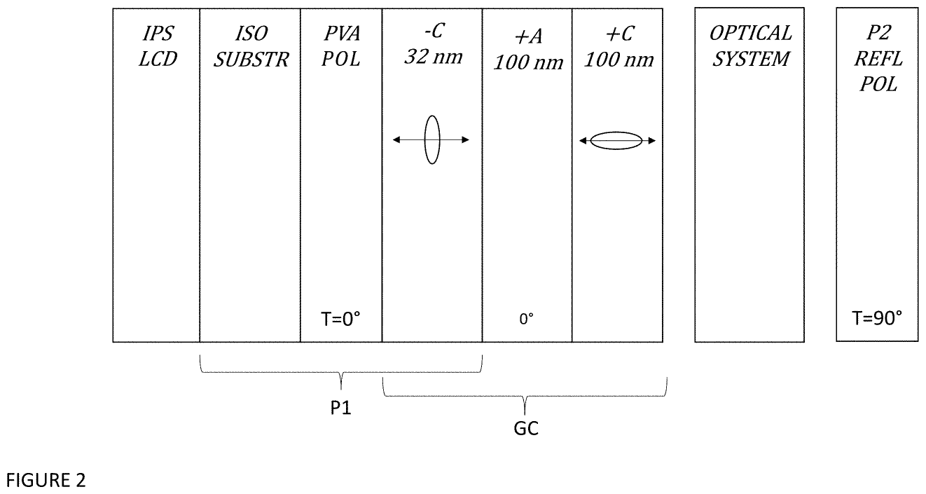

FIG. 2 shows an arrangement incorporating a three-element GC of the invention. A display is optically coupled to a linear input polarizer, consisting of a functional PVA layer (i.e. uniaxial absorber), bounded by transparent support substrates. The input substrate may have a function for optimizing the performance of the display (e.g. contrast over the FOV). In the case of an in-plane-switch (IPS) mode LCD, this substrate may be preferably isotropic. The output substrate in this case, shown as (triacetyl-cellulose) TAC with a 32 nm negative C-Plate retardation, has a functional benefit as part of the GC. A C-Plate is uniaxial with optic axis normal to the substrate. A positive C-plate has an in-plane refractive index lower than that in the thickness-direction, and a negative C-plate has an in-plane refractive index large than that in the thickness-direction. The subsequent elements include a 100 nm+A-plate (uniaxial in-plane retarder), and a 100 nm+C-Plate. The analyzer (P2) is shown as a crossed linear polarizer, which may be a reflective linear polarizer. Between the polarizers is a generic optical system, as required for (e.g.) a triple-pass lens.

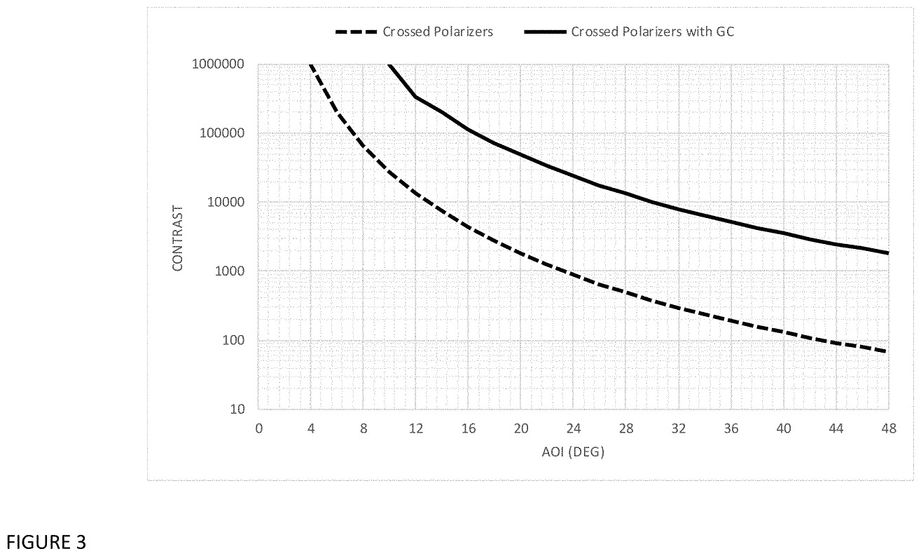

FIG. 3 shows the contrast versus incidence-angle of a conventional crossed-polarizer and that of the FIG. 2 system at the worst-case azimuth. In this example the optical-system shown in FIG. 2 has no polarization functionality (e.g. isotropic). With the GC present, the contrast is in general much higher. For example, the contrast of the crossed-polarizer at 40° AOI is only 130:1, and that with GC is 3,484:1; a factor of 27× improvement. To the extent that such a GC is incorporated to accomplish adequate contrast, optimization of first-pass light may become an exercise in designing the optical system shown to vanish over all relevant angles and wavelengths. Note that this approach serves only as an example of a broader solution space.

Partial-Reflector Polarization Distortion

Returning to FIG. 1, light exiting the input circular polarizer (P1+QW₁) has an ellipticity ε₁(θ, ϕ, λ), that is in general a function of angle-of-incidence (AOI), azimuth, and wavelength. QW₁ (and QW₂) can be characterized as having an in-plane retardation (or pathlength-difference) (Rₑ) including a wavelength-dependence, and a thickness-direction retardation (Rₜₕ) that describes any change in the SOP for off-normal rays. Similarly, coatings such as the partial-reflector (PR) can distort the SOP, particularly for off-normal rays. The transformation to ellipticity ε₂(θ, ϕ, λ) can be the result of retardation (phase-difference between S and P polarization), and diattenuation (transmission difference between S and P polarization) caused by the coating. The incidence angle on the coating is that formed between the ray-angle of image light, and the local surface-normal, which may be a compound-curved surface. For an azimuthally symmetric lens that is substantially centered on the optical axis, local-P is in the radial direction, and local-S is in the azimuth direction. In the present application, light incident on the partial-reflector has substantially circular polarization, and as such, the polarization distortion may follow the POI and be substantially independent of azimuth.

In one exemplary case, the partial reflector generally maintains the fidelity of the SOP produced by the circular polarizer (ε₂(θ, ϕ, λ)=ε₁(θ, ϕ, λ)). For this to be the case, the coating should have zero retardation and zero diattenuation for all incidence angles and wavelengths. This is extremely difficult for a thin-film coating design, though a compensator can be added (as described in co-pending U.S. Pat. App. No. 62/832,824, Polarization Compensator for Tilted Surfaces, the entire contents of which are incorporated herein by reference) to offset these issues. For instance, a matched C-plate retarder can be added to offset any coating Rₜₕ, and an absorptive C-plate can be added to balance S and P transmission. This element can be added to the output of QW₁, the input of QW₂, or both. Each compensator could be a single-layer that compensates for both diattenuation/retardation, or two layers, one that compensates for diattenuation, and another that compensates for retardation.

In the present system, where circular light is incident on the PR, retardation and diattenuation can have a very similar impact on performance. The distortion in ellipticity due to diattenuation produces an ellipse with orientation contained in the local POI, while that due to phase-difference is oriented at ±45° to the POI. However, when the distortion is introduced between ideal crossed circular-polarizers, it can be shown that the amount of light leakage through the analyzer depends only upon the magnitude of ellipticity distortion and that the resulting orientation of the ellipse is immaterial.

The Jones vector for the transmitted field in the local POI can be written as the product of three terms: an input circular polarization vector, the Jones matrix for the partial reflector, and the Jones matrix for an ideal crossed circular analyzer.

$$t = ( \begin{matrix}1 & 0 \\ 0 & 0\end{matrix} ) \frac{1}{\sqrt{2}} ( \begin{matrix}1 & i \\ i & 1\end{matrix} ) ( \begin{matrix}\sqrt{{T}_{S}} {e}^{- i Γ / 2} & 0 \\ 0 & \sqrt{{T}_{P}} {e}^{iΓ / 2}\end{matrix} ) \frac{1}{\sqrt{2}} ( \begin{matrix}1 \\ i\end{matrix} )$$

Where T_{S}, T_{P} represent the power transmission for S and P polarizations, respectively, and Γ is the phase-difference.

From the above equation, the total power leakage through the system due to a non-ideal partial reflector is given as the sum of two terms

$$T = {( \frac{\sqrt{{T}_{P}} - \sqrt{T s}}{2} )}^{2} + \sqrt{{T}_{S} {T}_{P}} {sin}^{2} Γ / 2$$

Where the first term is due to ellipticity distortion introduced by diattenuation and the second is that due to phase-difference. The contrast due to the contribution of the partial reflector is approximately the inverse of the above.

The challenge to producing a thin-film design that eliminates both of these terms over all angles and wavelengths is formidable. The invention anticipates that one or more additional polarization control layers can provide assistance in driving both terms to a negligible level over a wide FOV. This compensator can be added to the output of the first QW, the input of the second QW, or both.

Matching Rₑ and Orientation

The basic function of the triple-pass lens entails transformations between linear and circular polarization basis vectors, the specifics of which are part of second/third-pass optimization. In the context of the first-pass, normal incidence contrast is optimum when these transformations are completely offsetting. That is, the net polarization transformation from the pair of QW retarders is zero. In the case of a simple QW linear retarder, the first QW has orientation 45°, and the second QW has orientation −45°, or vice-versa. The product of the associated matrices is, at normal incidence, the identity matrix. These QWs may also be retarder-stack based, such as the Pancharatnam HW/QW pair. The crossed QW concept can be extended to retarder-stacks by using the “reverse-order-crossed” (ROC) arrangement, which in general gives the Jones identity matrix at normal incidence as described in the prior art. In the ROC arrangement, each retarder in a first stack is crossed with the counterpart layer of equal retardation in a second stack. However, and as described in a co-pending application (U.S. patent application Ser. No. 16/289,335, Retarder Stack Pairs for Polarization Basis Vector Transformations, the entire contents of which are incorporated herein by reference), the ROC arrangement represents an over-constraint, and other options for accomplishing this (i.e. eigen-polarizations of the stack-pair) may be preferred. Justification for an alternative stack-pair design is discussed in the next section.

In the ROC case, optimum contrast occurs on-axis when retarder layers in Stack 1 (QW₁) are matched in retardation and crossed with counterpart layers in Stack 2 (QW₂). From a practical standpoint, leakage of forward-pass light due to imprecise matching of the retarder layers can limit system contrast. In the case of web-manufactured (e.g. stretched polymer) retarders, or web-coated retarders (e.g. reactive-mesogen coatings) there is generally a statistical distribution of slow-axis orientation and retardation tolerances that can limit Rₑ matching of a stack-pair. Thickness uniformity is in general critical for maintaining retardation uniformity. This can be challenging for RMs, because the birefringence tends to be relatively large, and therefore the thickness tolerance is tighter. For cast/extruded film-based retarders, stretching uniformity is critical to controlling slow axis orientation and retardation cross-web.

A stack-pair with a composite rotation angle α and composite retardation Γ gives a transmission (to second-order) of

T=sin² α+sin² Γ/2

where in a triple-pass lens the contrast is given approximately by 1/(2T). For example, a lens with 5.5 nm of residual retardation (at 550 nm) or a rotation of 1.8° has a contrast of 1,000:1, and a lens with 12.4 nm or residual retardation or a rotation of 4° has a contrast of 200:1. In (e.g.) a Pancharatnam design, the stack pair may have a summed Rₑ of three half-waves (or about 800 nm), requiring that residual Rₑ is managed to a level of approximately 0.7% in order to maintain >1,000:1 contrast.

In addition to the as-fabricated statistics of the retarder material, robust performance demands that stresses caused by lamination, or changes in environmental conditions do not further compromise the performance. For instance, the lamination process may introduce stresses associated with the method in which the layers are brought together, thermal curing of adhesives, or differential thermal expansion of materials. Absorption of moisture can cause swelling that can introduce internal stresses. And retarder materials that are soft and have a high stress-optic coefficient (e.g. polycarbonate) can be particularly sensitive to these issues. Conversely, cyclic-olefin-polymer has relatively high-durometer, low stress-optic coefficient, and tends not to absorb moisture. It is also very low in haze.

Minimizing Composite Rₜₕ

Optimizing the first-pass at normal-incidence requires no specific polarization transformation from either QW₁ or QW₂. Assuming geometric compensation is present, it may only demand that the combination vanish in order that the SOP at P2 is linear along the reflection axis. That is, we require that ε₃(θ, ϕ, λ)=0, with orientation along the reflection-axis. For general retarder-stacks, the reverse-order-crossed (ROC) arrangement of QW₁/QW₂ of the prior art accomplishes this. Provided that there is zero net Rth from the stacks, the ideal situation persists for all AOI. However, the practical reality of using readily available uniaxial retarders (Nz=1 (or Rₜₕ=½), versus ideal Nz=0.5 (or Rₜₕ=0) retarders) is that accumulation of Rₜₕ is likely inevitable and some additional compensation is needed for wide-angle systems. A practical form of compensation for Rₜₕ is a +C-Plate that corrects for the entire stack-pair. But that may require that the SOP in the space between QW₁ and QW₂ has some azimuth insensitivity, such that an azimuth-independent compensator (i.e C-Plate) can have a positive overall impact. In many instances, ROC configurations are not effectively compensated with a C-Plate, due to azimuthal dependence of the stack-pair.

As described in co-pending application (U.S. patent application Ser. No. 16/289,335, Retarder Stack Pairs for Polarization Basis Vector Transformations, the entire contents of which are incorporated herein by reference), there are alternatives to ROC, which are termed “non-degenerate eigen-polarizations”. A set of solutions from this space is the reverse-order-reflection-about-zero (RORAZ) configuration, where each layer in a first stack has a matched-retardation counterpart in the second stack with sign of angle reversed. The RORAZ configuration can perform very well, particularly when the optimum +C-Plate is applied between the stacks. In fact, the combination of QW₁ and QW₂ can deliver higher contrast over AOI/Azimuth than the simple ideal crossed polarizers discussed previously. This indicates that some level of geometric compensation in the 45° azimuth can be enjoyed without adding an additional geometric compensator stack upstream of QW₁ (or downstream of QW₂).

Embodiment of Optimized First-Pass

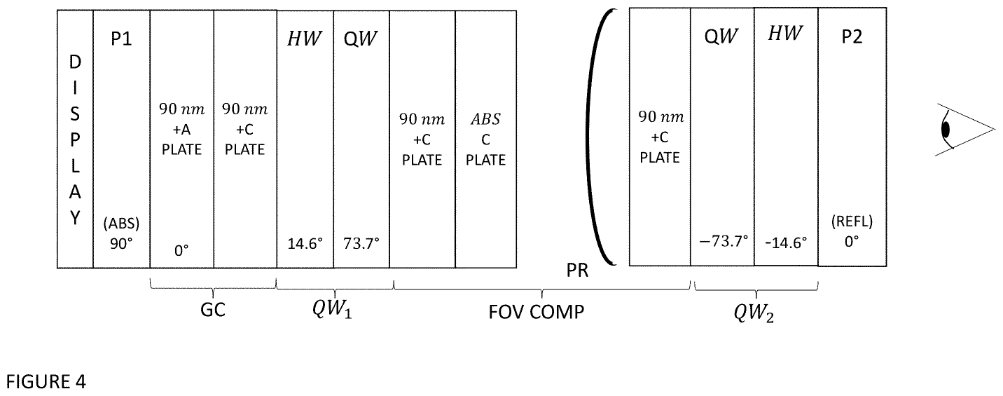

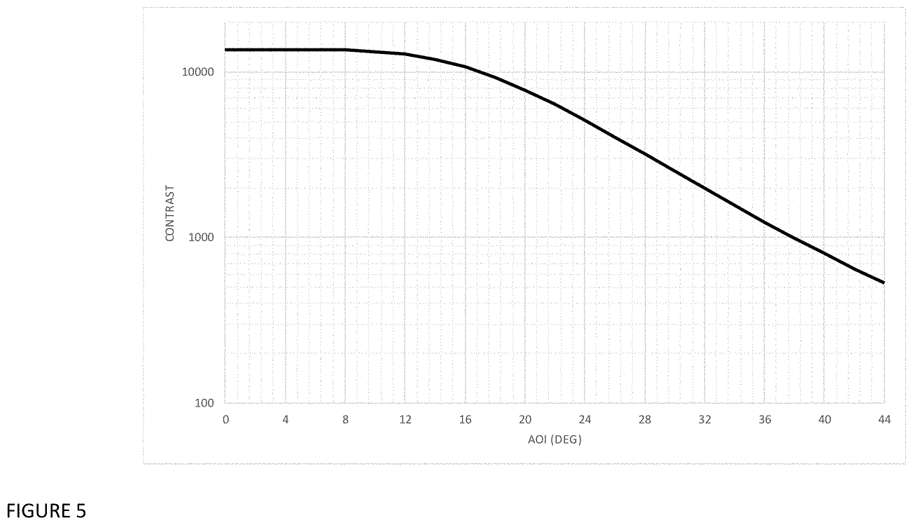

FIG. 4 is an embodiment of an optimized version of the first-pass (FIG. 1) configuration. Though first-pass optimization (i.e. a null in transmission) requires no specific polarization basis-vector transformation, it is appropriate to insert a specific CP design to illustrate some of the optimization principles described above. In this case, a Pancharatnam CP is used to generate the SOP for the input to the cavity. The RORAZ counterpart is inserted between the PR and the reflective-polarizer. A pair of +C-Plates with a combined retardation of 180 nm are inserted between the stacks on either side of the partial reflector. An absorptive uniaxial C-Plate can be inserted to offset any diattenuation that may occur in transmission through the partial reflector. An A/C-Plate GC is inserted between the input polarizer and QW₁, as shown. FIG. 5 shows the contrast versus AOI at the worst-case azimuth for the configuration of FIG. 4. Unlike ROC, which has theoretically infinite contrast at normal incidence, the contrast here is limited by the residual wavelength-dependence of the eigen-polarization. At normal incidence (and to well over 10°), this contrast remains approximately 14,000:1. More significantly, the contrast remains above 1,000:1 out to 38°.

There are some specific details of the FIG. 4 configuration that are worth noting. First, there is a design option for inputting either 0° or 90° polarization to the first stack (i.e. analyzing 90° or 0° polarization, respectively). Better contrast performance is achieved in this example by inputting 0° polarization, which is why the absorption axis is shown along 90°. Second, in this example the input polarizer exit substrate is preferably isotropic (i.e. has no C-Plate retardation), which would otherwise compromise the performance at large incidence angle. Third, the net C-Plate retardation value selected (180 nm) is based on a low-birefringence retarder (0.01) with an average index of 1.52. If this were to change (e.g. to 1.60), the optimum Rₜₕ value would need to be adjusted upward. This is because an increase in mean refractive index represents a decrease in the ray angle in the retarder, and thus a reduction in projected Rₜₕ. Fourth, the example assumes that there is zero Rₜₕ associated with the reflective polarizer, and thus that (e.g.) linear incident polarization in general remains unchanged prior to being analyzed. Sixth, the geometric compensator can be located after the input polarizer, or before the analyzer. By locating it after the input polarizer, it has no impact on second/third-pass light. By locating it at the analyzer, it may contribute to the SOP in both second and third-pass light. Seventh, all retarders are assumed uniaxial and dispersionless (i.e. no wavelength dependence of pathlength-difference). Eighth, the diattenuation compensator, being a uniaxial absorber, is likely to also have significant Rₜₕ. The 180 nm C-Plate compensator selected neglects this contribution, though the overall objective remains consistent; to drive the net Rₜₕ associated with the full stack to a minimum value. The composite Rₜₕ is associated with the crossed QWs, the partial-reflector, and the diattenuation compensator. In practical terms, it may be that the actual optimum +C-Plate value is adjusted from 180 nm to achieve overall objectives.

FIG. 5 shows the contrast versus incidence angle at the worst-case azimuth for the design of FIG. 4. The contrast is 10,000:1 at 17°, 5,000:1 at 24°, 2,000:1 at 32°, and 1,000:1 at 38°.

Second/Third Pass Optimization

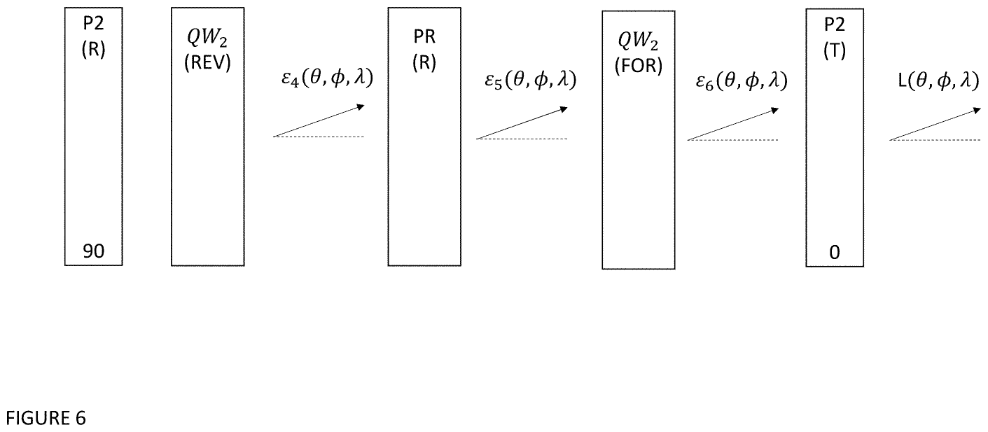

FIG. 6 shows an exploded and unfolded arrangement representing second and third passes of the cavity. In this case, light is re-introduced to the cavity by the 90°-oriented reflective polarizer. In the case where the reflective polarizer is e-type in reflection and o-type in transmission (or vice-versa), geometric rotation issues of the crossed-polarizers can be much reduced for off-normal light. This type of self-compensation is beneficial in that it can eliminate the compensation as described for first-pass optimization. In the event that the reflective polarizer exhibits any biaxiality (such as a C-Plate behavior), compensation can be added to minimize the introduction of ellipticity from interactions with the reflective polarizer.

Light polarized along the reflection axis first executes a reverse-pass through QW₂, giving an ellipticity represented by ε₄(θ, ϕ, λ) which is ideally unity. Light then reflects from the partial reflector, which can also distort ellipticity via diattenuation and retardation. Because this is an unfolded arrangement, it is represented as a transmissive component that transforms the SOP to an ellipticity of ε₅(θ, ϕ, λ). Finally, light follows a forward-pass through QW₂ where it emerges with ellipticity ε₆(θ, ϕ, λ). In this case, the SOP is ideally linear (ε₆(θ, ϕ, λ)=0) with projection in general orthogonal to the reflection axis. If accomplished precisely, image light exits efficiently and the reflective polarizer returns no light to the cavity. The former speaks to the incremental throughput benefit of optimization, but more importantly, by not introducing light back to the cavity the optimized design does not permit subsequent passes to spawn additional ghosts. The optimization could be accomplished by either maximizing the projection orthogonal to the reflection axis, or by minimizing the projection along the reflection axis.

Double-Pass of QW₂: In-Plane Retardation (Rₑ)

In the case of the second/third-pass, optimization relies heavily on the function of QW₂ in double-pass. This is because minimizing the projection along the reflection axis is equivalent to converting light at all relevant wavelengths and incidence angles to the orthogonal SOP. In other words, the double-pass of QW₂ ideally delivers a half-wave of retardation over all wavelengths and incidence angles.

At normal incidence, a very specific reverse-dispersion function is required to optimize a double-pass HW over the visible band. This can be accomplished either through synthesizing designer (e.g. polymer or RM) molecules, engineering retarder-stacks, or some combination of the two. Retarder-stacks have the benefit that an arbitrary level of Rₑ control can be achieved by simply adding more layers, and therefore the precision it affords makes it the focus of this optimization.

In the case where QW₂ is a retarder-stack there is a fixed relationship between the two passes of the structure. This is the reverse-order (RO) arrangement discussed in the prior art (see for example p. 145-148 of “Polarization Engineering for LCD Projection”). The number of layers and orientation of each layer may be selected to produce an arbitrarily precise approximation to the ideal dispersion relationship

$$Δ n ( λ ) = \frac{λ}{4 d}$$

Where λ is the wavelength and d is the retarder thickness. With only two layers, the Pancharatnam-type CP typically performs better than any commercially available single-layer dispersion-controlled retarder. By going beyond this and adding a greater number of half-wave retarders, the approximation to the above can be further improved. In the unfolded arrangement, the RO stack may take the form of an odd number of half-wave retarders. When divided to form a CP, the QW₂ structure becomes an arbitrary number of half-wave retarders followed by a single QW retarder. An example of a four-layer CP is used to illustrate the contrast improvement that can be achieved when further tailoring the dispersion function.

Minimizing Composite Rₜₕ of QW₂ Double-Pass

A potential tradeoff associated with adding additional layers to tailor the wavelength-dependence of Rₑ is that it can also increase the composite Rₜₕ, and thus compromise the performance off-normal. The invention recognizes this, with the selection of a stack that has a self-compensation function. This refers to the fact that the composite Rₜₕ of an exemplary design is a minimal fraction of the total stack Rₑ. Furthermore, an exemplary design may show an azimuth dependence of Rₜₕ that responds favorably to C-Plate compensation. Again, an example of a four-layer CP design that maintains performance over a broad range of incidence angles is presented.

Minimizing Partial-Reflector Polarization Distortion in Reflection

As discussed in the forward-pass optimization, diattenuation and phase-difference can also occur from reflection at the partial-reflector. The result is very similar to the transmission case, with the transmission coefficients replaced by reflection coefficients, and substitution of reflection phase-difference. In this case the reflectivity of S-polarization usually exceeds that of P, which would tend to call for an anisotropic absorber that minimizes diattenuation by AOI-sensitive absorption of S-polarization. This is the reverse of the transmission-mode compensator, and may be more difficult to implement in practice. However, the incidence angle on the partial reflector may be smaller for second-pass light than for first-pass light, which would tend to diminish the need for diattenuation compensation. The compensation of phase-difference can still be minimized by an adjustment in a +C-Plate compensator that can reside between QW₂ and the partial reflector.

Embodiment of Optimized Second/Third-Pass

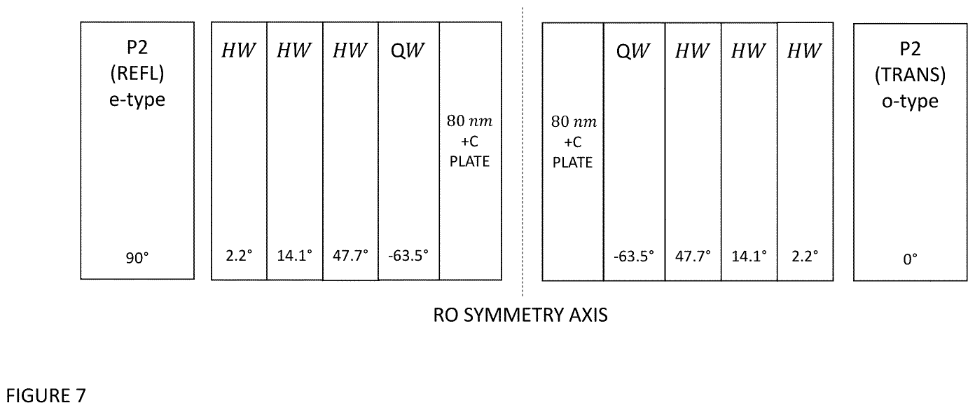

While the example of FIG. 4 illustrates the features that may be required to optimize first-pass light, no particular attention was given to that of second/third pass light. In the case of the Pancharatnam design used, the reverse-order (RO) parallel-polarizer leakage of QW₂ gives a contrast of approximately 1,200:1 at normal incidence. Higher contrast thus requires a stack design with higher double-pass conversion efficiency, ideally without introducing the tradeoff associated with increasing Rₜₕ. FIG. 7 shows an embodiment of an exploded-unfolded optical configuration of FIG. 6 that additionally optimizes second/third-pass light. The most significant change relative to the previous example is the emphasis on QW₂ performance. This design has an additional two half-wave layers relative to the Pancharatam design (four retarders per stack), which gives greater dispersion control and thus allows better normal-incidence performance. In this example the reverse-order (RO) parallel-polarizer leakage of QW₂ gives a theoretical contrast of more than 50,000:1 at normal incidence. Note also that the RORAZ crossed-polarizer contrast in this case is theoretically over 77,000:1, versus 13,700 for the Pancharatnam design. But importantly, the additional Rₜₕ of this particular design does not compromise the angle-dependence of first-pass contrast relative to the Pancharatnam design. Both designs give a first-pass contrast of approximately 2,000:1 at 32° AOI. In order to optimize the performance over angle, +C-Plate compensators are added on either side of the symmetry axis, as shown.

FIG. 7 also shows the two interactions with the reflective polarizer as an e-type polarizer in reflection and an o-type polarizer in transmission, respectively. In this case there is assumed no phase-difference from either interaction that requires compensation. Also, any adjustment in C-Plate retardation to account for reflection from the partial-reflector can be made, as described previously. To the extent that parallel o-type polarizers approximates the crossed o-type and e-type polarizers, the model should adequately account for the (common) geometric rotation.

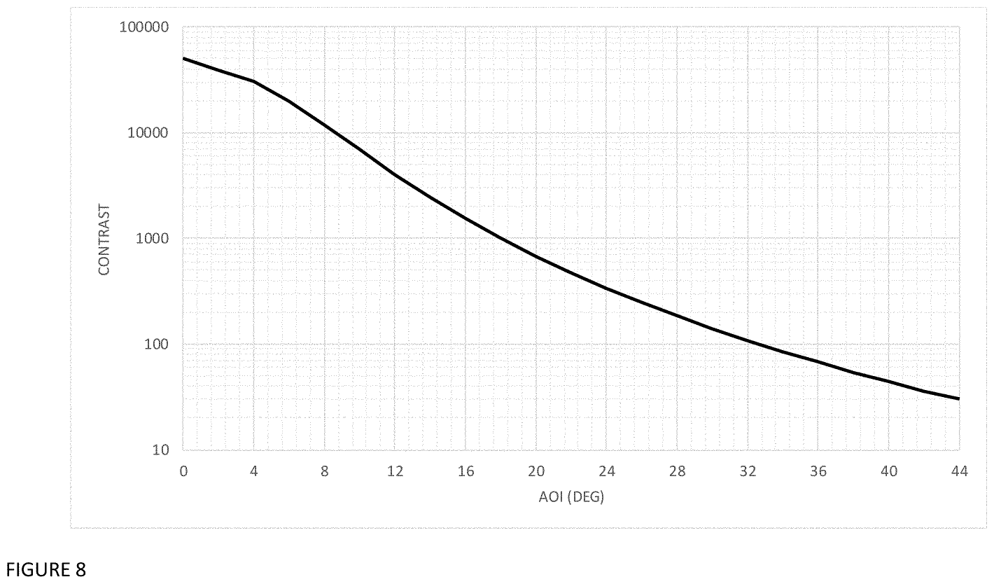

FIG. 8 shows the parallel-polarizer leakage of the RO stack of FIG. 7 at the worst-case azimuth. Because the double-pass is required to convert all wavelengths (photopically-weighted) to the orthogonal SOP to maintain high contrast, the falloff in contrast with incidence angle is more precipitous than it is for first-pass optimization. The contrast is 10,000:1 at 9° and 1,000:1 at 18.5°.

Example of an Optimized Triple-Pass Lens

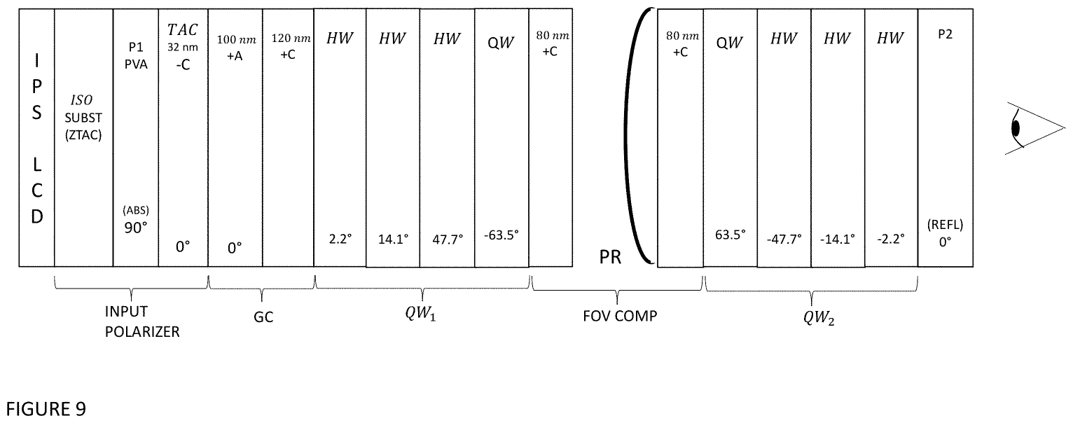

An example lens of the invention that integrates the results of first-pass and second/third-pass optimization is shown in FIG. 9. An IPS-mode LCD has an analyzing polarizer with an isotropic input substrate, a functional PVA o-type polarizer, and a TAC output substrate with 32 nm of −C-Plate retardation. The latter is typically an inherent aspect of the TAC substrate, which also serves as a functional layer of the geometric compensator (GC). The GC further consists of an A-plate/C-plate combination as described previously. This polarizer also serves as the input for the first circular-polarizer, which in this case is the four-layer design describe previously. Also as shown previously, C-plate compensation is placed at the exit QW₁ of, and at the input of QW₂, each on opposite sides of the partial reflector (PR). The compensation shown is that required to optimize the performance of the uniaxial RORAZ stack and does not include any effect of the PR. As discussed previously, adjustments may be required to optimize the compensation when the effect of the PR is added, including phase and diattenuation.

Fresnel Reflection Ghosts

A monolithic display construction (i.e. optical coupling between all layers) can minimize unnecessary (Fresnel) reflections that can spawn ghost images. But there may be valid justification for accepting air gaps in the optical system. It may be related to the need for pathlengths between surfaces that are too large to optically couple, the presence of gaps between surfaces with dissimilar curvatures, design-for-manufacturing considerations, dynamic/variable-focal pathlength adjustment requirements, and practical performance tradeoffs involved in optical coupling. For instance, an optical system requiring several millimeters between the display stack exit and the first surface of the lens may create a preference for an air space. An aspect of the invention is the acknowledgement that tradeoffs associated with air-spaces may create a preference for accepting certain Fresnel reflections. But importantly, the invention seeks to identify architectures where such reflections have weak coupling to the lens output, particularly when they represent in-focus ghosts.

Optically coupling adjacent surfaces wherever practical using an index-matching dielectric is usually preferred. However, this can become challenging when; (1) optical pathlengths between surfaces are necessarily large (e.g. as required for optimizing the optical system design), (2) the surfaces do not possess the same curvature (either for functional or practical reasons), and; (3) it is impractical to fill such gaps in a manufacturing assembly process. When an air-space is necessary, antireflection coatings can drive reflections from 4% to below 0.2% at normal incidence. But this may not be sufficient in practice. And in wide-angle systems, the aggregate reflection can be significantly worse when using thin-film AR coatings.

In a polarization-based triple-pass collimating lens, introducing any coupling dielectric that affects the SOP is likely to compromise performance, especially in a thick section. A material that cross-links, such as a silicone gel, may have induced birefringence either as-cured, or induced by changes in environment (e.g. temperature/humidity) and mechanical stress (e.g. potting). If, say, a polymer is used to couple a planar surface and a compound-curved surface, the material has a non-uniform thickness. When cross-linked, there may be residual stress that results in retardation. Also, while haze may be extremely small in typical adhesive sections (10-100 microns), it may have a significant impact on performance in sections over a millimeter thick. Additionally, thick section of coupling material can add significant weight and create manufacturing challenges.

Functional layers of the optical system may have compound-curved surfaces required for either refractive or reflective power that may be composed of either glass or polymer. The former may have low birefringence but is relatively heavy, while the latter may be light-weight but may have significant birefringence. In the case of refractive material, optical power is derived from an optical pathlength difference that may preclude the use of optical coupling materials. Conversely, reflective power can occur in a buried surface, as shown in the prior-art system of Hoppe (U.S. Pat. No. 6,075,651). Fundamentally, an all-reflective architecture has the potential for implementing the lens in a monolithic stack, which may be optimum from the perspective of minimizing stray reflection ghosts. But again, the effects of the additional dielectric material on the SOP, image quality, and weight may create a tradeoff.

Consider a polarization-based triple-pass lens that requires an air space between the display stack and the input surface of the lens. In prior-art systems, image light is typically derived from the initial partial-reflector transmission, with the initial reflection (ideally) extinguished. The approximate 50% reflected is returned to the lens with amplitude proportional to the display-stack Fresnel reflectivity. And because this light shares the same SOP as the image light, it is efficiently coupled to the output and creates a ghost.

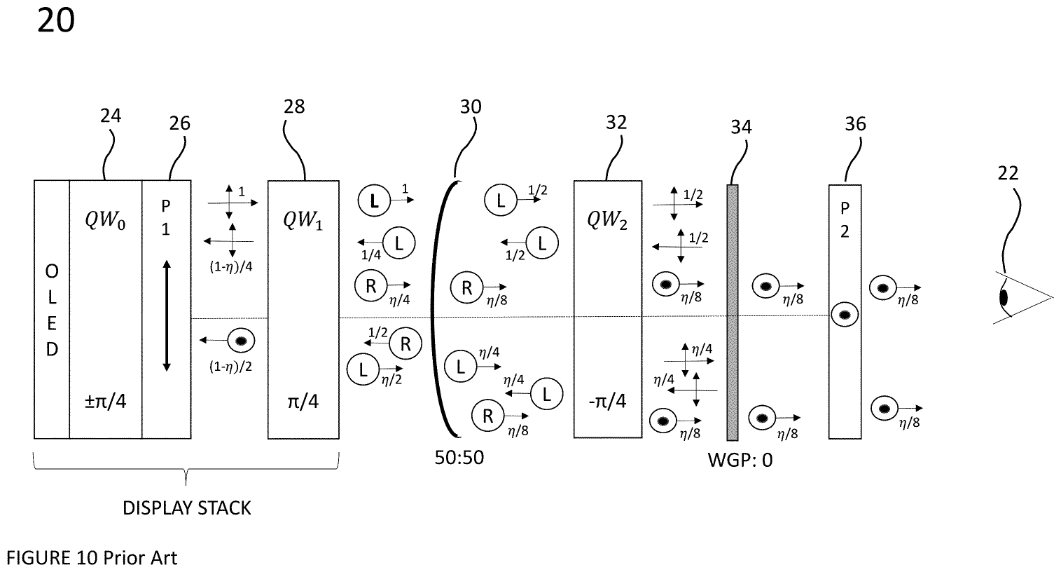

FIG. 10 shows an optical system of the prior-art useful for a virtual-reality headset 20, where observer 22 views an electronic display (in this case an organic light-emitting display (OLED)) through a triple-pass lens. An exploded view is shown to facilitate polarization tracing, though it is assumed that an air-space exists only between the display-stack and lens, with the lens having optical coupling between all layers. Two polarization traces are shown (separated by a dashed line). The additional insertion-loss of optical components (e.g. polarizers and partial reflector absorption) is not included in this analysis. The display-stack may contain a broad-band quarter-wave (QW₀) retarder 24 and linear polarizer 26 which together act to absorb ambient light reflected from the backplane electrodes. In an LCD, there may only be a linear display analyzing polarizer.

Image light of unity power is converted to left-hand circular SOP by broad-band QW retarder 28 (QW₁), 50% of which is transmitted into the cavity by partial reflector 30. A second broad-band QW retarder 32 (QW₂) (e.g. crossed with the first) restores the input linear SOP. Reflective polarizer 34 is oriented to return all light to the cavity. This element may be plano, cylindrical, or may be compound-curved (e.g. thermo-formed) to provide optical power. LH-circular light from QW₂ undergoes a handedness change at partial reflector 30 (producing right-hand circular polarization), also incurring a further 50% loss on reflection. The additional round-trip of the cavity thus converts light to the orthogonal SOP, where it is efficiently transmitted by reflective polarizer 34. This light may then pass through a clean-up polarizer 36. The prior-art triple-pass lens may thus have a maximum efficiency of 25%, where the remaining 75% back-reflected to the display is (at best) absorbed by the display polarizer. Some of this light may alternatively contribute to stray light and ghosts that degrade contrast and overall quality of the imagery. There are two significant display-reflection ghosts; one spawned by the initial (50%) reflection of the partial-reflector, the other spawned by the (25%) second-pass light that is transmitted through the partial reflector.

The 50% of circularly-polarized light initially returned by partial-reflector 30 is (ideally) converted to the orthogonal linear SOP by QW₁ 28, and absorbed by polarizer 26. This light is converted to heat at the display. This term is illustrated in the lower trace of FIG. 10. A portion of the return light is also reflected by the outer surface of QW₁ and reflected back toward partial reflector 30. Since this light has the same SOP as image light, it can efficiently follow the image-path to the viewer. Since the image light has an (ideal) amplitude of 25%, the associated signal-to-ghost contrast (SGC) is approximately twice the inverse of the reflectivity of the QW₁ surface. A good AR coating can deliver >200:1 contrast, giving an overall SGC of about 400:1.

The 25% of second-pass light that is transmitted by the partial-reflector, illustrated in the upper trace of FIG. 10, is also incident on the surface of QW₁ 28. After reflection from the external surface of QW₁, this light has the same SOP as image light. Half of this light is transmitted by the partial reflector 30 and emerges from QW₂ 32 polarized along the transmission axis of the reflective polarizer. As before, this ghost has an SGC of twice the inverse of the reflectivity of the QW₁ surface.

When an air-space is required between the display-stack and lens, a preferred design minimizes the coupling of (Fresnel) reflections from the display surface. In a configuration of the invention, image light can be derived from the initial partial-reflector reflection, with the initial transmission (ideally) extinguished. This involves flipping the lens around, such that (e.g.) a curved reflective polarizer is at the input and the plano partial reflector is at the output. The display outputs linear SOP, which has the benefit of simplifying the display stack. Additionally, the orientation sensitivity of the display stack to the lens is weak, since improper orientation represents an incremental throughput loss. The prior art input circular polarizer (i.e. addition of 28) is moved to the output and is used to select image light for transmission, while absorbing first-pass light.

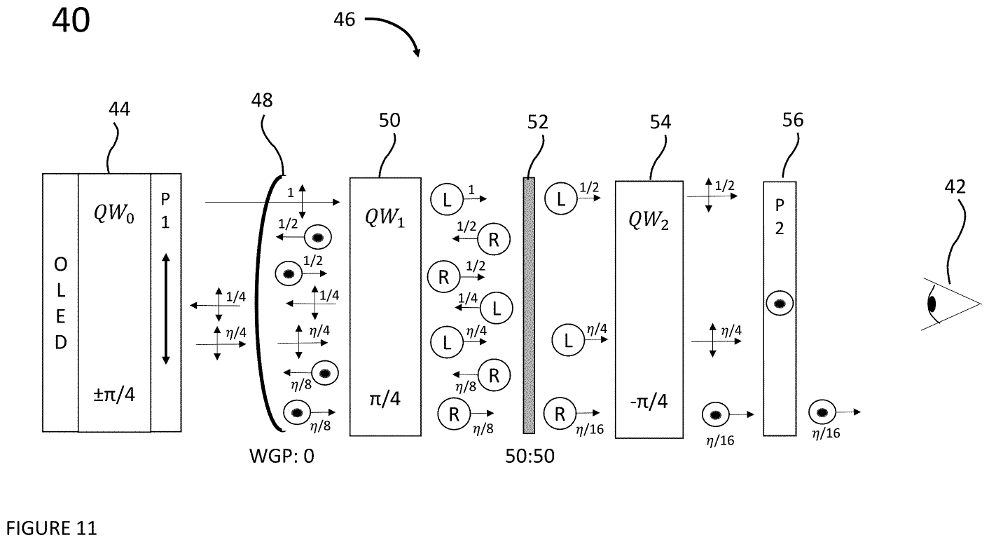

FIG. 11 of the invention shows an alternative to the prior-art configuration, where the reflective elements forming the cavity are reversed. This is an exploded view for polarization tracing, but it can be assumed that an air-space exists only between the display and lens as before. FIG. 11 shows optical system 40, where observer 42 views an electronic display system 44, through a triple-pass lens 46 of the invention. This example shows an organic light emitting diode (OLED) display with circular polarizer, as before, which could alternatively be a liquid-crystal display. In this case, the display stack contains no triple-pass lens-specific elements (except perhaps an AR coating on the output face), unlike the prior art.

For illustrative purposes, the components are taken to have zero insertion-loss. Reflective polarizer 48 (WGP) transmits light from the display polarized in the plane of the figure into the cavity. The orientation of the display polarizer is non-critical, with any errors mainly producing an incremental throughput loss. Moreover, small birefringence issues due (e.g.) to a substrate on the convex surface of the reflective polarizer, may produce an incremental throughput loss without affecting the contrast, since the reflective polarizer cleans up the SOP. The double-reflections from the exposed surfaces between the display stack and reflective polarizer should render the associate ghost relatively insignificant. A broad-band quarter-wave retarder 50 (QW₁) in this example converts the polarization to left-handed circular. A geometric compensator (not shown) may be placed in the cavity (between 48 and 50), which accounts for geometric rotations discussed previously, as well as the curvature of the reflective polarizer. The 50:50 partial reflector 52 transmits half of the incident light. The other 50% reflects from the partial reflector and is converted to right-handed circular, and subsequently image light. In this example, the reflective polarizer is curved and the partial reflector is flat, but either or both reflector surfaces could be curved. However, certain configurations may also utilize thermoforming of polarization optics (e.g. QW₂) in order to eliminate air-spaces.

Quarter-wave retarder 54 (QW₂) in this example has slow-axis perpendicular to that of QW₁, so after passing through QW₂ the original linear SOP is restored. First-pass light transmitted by partial reflector 52 is substantially absorbed by linear polarizer 56, with absorption axis in the plane of the figure. This is the term that normally reflects back to the display in the prior art system, producing the ghost from the exit surface of the display stack. An air-space between partial reflector 52 and QW₂ 54 would produce a term with the amplitude of return light (η/4) similar to that associated with the prior art system, but optically coupling is assumed here.

The 50% reflected by partial-reflector 52 makes a second pass of QW₁ which converts the SOP to linear, polarized normal to the figure. This light reflects from reflective polarizer 48. After a third pass of QW₁, the SOP is again right-hand circular polarized, with handedness reversed after a second reflection of the partial reflector. This 25% is converted to linear SOP after a fourth pass of QW₁, polarized parallel to the transmission axis of the reflective polarizer. Most of this light is transmitted into the display, but a portion (reflectivity η) reflects from the display stack and again passes through the reflective polarizer. For passes 5-7, the polarization trace is the same as passes 1-3, with the ghost diminished in amplitude to η/16 upon exiting the cavity. Assuming index matching between all other layers this is the most significant Fresnel ghost term (SGC of four times the inverse of the display reflectivity) and may be more defocused than the display reflection ghosts of the prior art system.

There may be manufacturing-process benefits of the example of the invention, relative to the prior art. First, the display stack can be manufactured in the conventional way by the display manufacturer without introducing any exotic materials (e.g. QWs). Adding an AR coating to the display exit face is fairly standard. Second, the compound-curved reflective polarizer can be fabricated as a stand-alone component. It can be thermoformed and then insert-molded, with a mechanical support substrate affixed to the convex surface. AR coatings can be applied to either/both surfaces of the reflective polarizer. Birefringence issues in the external support substrate may be relatively inconsequential from a contrast standpoint, only producing an incremental loss in throughput. Third, sheet-scale fabrication of the polarization optics stack can be performed, followed by singulation. For example, one fabrication sequence could be as follows: (1) Laminate separate QW₁ and QW₂ stacks; (2) Laminate polarizer to QW₂; (3) Laminate QW₁ to partial reflector; (4) laminate (QW₂+Polarizer) to partial reflector; (5) singulate and bond lens. Step (2) represents a critical orientation alignment, as is the alignment of the finished stack to the reflective polarizer. The latter may be done as a final optical alignment. The partial reflector may be fabricated on an isotropic substrate, such as cell-cast acrylic, adding mechanical support and introducing negligible birefringence. A geometric compensator may be added to the input of QW₁ for managing geometric rotations introduced by the formed reflective polarizer.

Incremental Reflections and Haze

Many of the stray-light contributors that are individually small can collectively limit the quality of the visual experience. Random scatter from small features in substrates (internal/interfacial) and laminating adhesives, and incremental reflections from improper index-matching can create background light that limits the contrast of blacks and desaturates colors. It can also create veiling-glare that limits image sharpness by bleeding bright-state light far into dark regions.

Consider the case where a Pancharatnam-like stack is used to transform back/forward between linear and circular polarization. If a COP stack (n=1.52) is assembled with pressure sensitivity adhesives (n=1.46), the reflectivity of a single interface is approximately 0.04%. In the case of FIG. 4, containing an input circular polarizer and a C-Plate with isotropic substrate, there may be a total of 12 interfaces. Once inside the lens, there may be 10 additional interfaces, with three passes, for a total of 30 interfaces. The total power in reflection that is at play for the 42 interfaces may be as large as 1.7%, which can severely limit overall contrast. With polycarbonate (n=1.59), this reflection can be much larger.

In an exemplary build of the invention, interfaces between the (like) retarder layers are eliminated via index-matched adhesives or solvent bonding. Moreover, high-index adhesives (e.g. urethanes or urethane acrylates) can virtually match dissimilar substrates such as glass-to-retarder, polarizer-to-retarder (TAC to COP), and retarder-to-glass. Alternatively, a chemical-grafting can be used for joining dissimilar substrates, similar to that for attaching PVA to TAC. One challenge involves index matching to the RM C-plate.

We claim:

1. A wide-angle polarization-based triple-pass lens, comprising:
an input polarizer producing a first transmitted linear polarization;
a first retarder-stack for converting from linear-polarization to circular-polarization;
a curved partial-reflector;
a second retarder-stack for converting from circular-polarization to linear-polarization;
a reflective linear-polarizer; and
a geometric-compensator (GC) between the input polarizer and the first retarder-stack, the second quarter-wave retarder and the reflective linear-polarizer, or both;
wherein, the GC reduces the first-pass transmission of the lens for rays incident off-normal.

2. The lens of claim 1, wherein the absorptive linear-polarizer is o-type in transmission, the reflective-polarizer is o-type in reflection, and the absorption-axis is crossed with the reflection-axis.

3. The lens of claim 1, wherein the geometric-compensator is comprised of a positive A-plate with 70-130 nm of phase-difference, and a positive C-plate with 70-130 nm of phase-difference.

4. The lens of claim 1, wherein the second retarder stack has a reverse-order-reflection-about-zero relationship with the first retarder stack.

5. The lens of claim 4, further including a positive C-plate between the first retarder-stack and the partial-reflector, the partial-reflector and the second retarder-stack, or both, wherein the positive C-plate retardation is selected to minimize the transmission of first-pass light for rays incident off-normal.

6. The lens of claim 5, further including a diattenuation-compensator between the first retarder-stack and the partial-reflector, the partial-reflector and the second retarder-stack, or both, wherein the absorption of the diattenuation-compensator is selected to minimize the transmission of first-pass light for rays incident off-normal.

7. A wide-angle magnified imaging system, comprising:
a display device;
an input polarizer producing a first transmitted linear polarization;
a first retarder-stack for converting from linear-polarization to circular-polarization;
a curved partial-reflector;
a second retarder-stack for converting from circular-polarization to linear-polarization;
a reflective linear-polarizer; and
a geometric-compensator (GC) between the input polarizer and the first retarder-stack, the second quarter-wave retarder and the reflective linear-polarizer, or both;
wherein, the GC reduces the first-pass transmission of the lens for rays incident off-normal.

8. The imaging system of claim 7, wherein the absorptive linear-polarizer is o-type in transmission, the reflective-polarizer is o-type in reflection, and the absorption-axis is crossed with the reflection-axis.

9. The imaging system of claim 7, wherein the geometric-compensator is comprised of a positive A-plate with 70-130 nm of phase-difference, and a positive C-plate with 70-130 nm of phase-difference.

10. The imaging system of claim 7, wherein the second retarder stack has a reverse-order-reflection-about-zero relationship with the first retarder stack.

11. The imaging system of claim 10, further including a positive C-plate between the first retarder-stack and the partial-reflector, the partial-reflector and the second retarder-stack, or both, wherein the positive C-plate retardation is selected to minimize the transmission of first-pass light for rays incident off-normal.

12. The imaging system of claim 11, further including a diattenuation-compensator between the first retarder-stack and the partial-reflector, the partial-reflector and the second retarder-stack, or both, wherein the absorption of the diattenuation-compensator is selected to minimize the transmission of first-pass light for rays incident off-normal.

13. A wide-angle magnified imaging system with reduced ghosting, comprising:
a display device;
an input absorptive polarizer affixed to the display device producing a first transmitted linear polarization;
a curved reflective linear-polarizer physically separated from the input polarizer;
a first retarder-stack for converting from linear-polarization to circular-polarization;
a partial-reflector;
a second retarder-stack for converting from circular-polarization to linear-polarization; and
an analyzing absorptive linear polarizer with absorption-axis crossed with the input polarizer absorption-axis.

14. The wide-angle magnified imaging system of claim 13, wherein the curved reflective-polarizer, the first retarder-stack, the partial reflector, the second retarder-stack, and the analyzing polarizer are all optically coupled to minimize reflections.

15. The wide-angle magnified imaging system of claim 14, wherein the curved reflective polarizer forms an input convex surface and the concave surface is filled with an isotropic index-matching dielectric, forming a planar surface for coupling to the input retarder-stack.

16. The wide-angle magnified imaging system of claim 13, wherein the partial-reflector is planar.

17. The wide-angle magnified imaging system of claim 13, wherein the curved reflective polarizer is physically separated from the first retarder-stack, and the first-retarder stack, the partial reflector, the second retarder-stack, and the analyzing polarizer are all optically coupled.

18. The wide-angle magnified imaging system of claim 17, wherein the output surface of the curved reflective polarizer and the input surface of the first quarter-wave retarder have an anti-reflection coating.

19. The wide-angle magnified imaging system of claim 13, further comprising a geometric-compensator (GC) between the reflective polarizer and the first retarder stack, the second retarder-stack and the analyzing absorptive polarizer, or both;
wherein the GC reduces the first-pass transmission of the lens for rays incident off-normal.

20. The wide-angle magnified imaging system of claim 19, wherein the geometric-compensator is comprised of a positive A-plate with 70-130 nm of phase-difference, and a positive C-plate with 70-130 nm of phase-difference.

21. The wide-angle magnified imaging system of claim 19, wherein the second retarder stack has a reverse-order-reflection-about-zero relationship with the first retarder stack.

22. The wide-angle magnified imaging system of claim 21, further including a positive C-plate between the first retarder-stack and the partial-reflector, the partial-reflector and the second retarder-stack, or both, wherein the positive C-plate retardation is selected to minimize the transmission of first-pass light for rays incident off-normal.

23. The wide-angle magnified imaging system of claim 21, further including a diattenuation-compensator between the first retarder-stack and the partial-reflector, the partial-reflector and the second retarder-stack, or both, wherein the absorption of the diattenuation-compensator is selected to minimize the transmission of first-pass light for rays incident off-normal.
